(19) United States
(12) Patent Application Publication
(10) Pub. No.: US 2026/0083097 A1
(43) Pub. Date: Mar. 26, 2026

(54) VERTICALLY PLACED CAT SCRATCHING POST FOR USE WITH BRACKET

(71) Applicant: Tatiana Nikolaevna MOSALOVA, Moscow (RU)

(72) Inventor: Tatiana Nikolaevna MOSALOVA, Moscow (RU)

(21) Appl. No.: 19/191,488

(22) Filed: Apr. 28, 2025

(30) Foreign Application Priority Data
Sep. 23, 2024 (RU) 2024128067

(51) Int. Cl. A01K 15/02

(52) U.S. Cl. CPC A01K 15/024

(57) ABSTRACT

The proposed invention relates to household items, more specifically to brackets for placing a product or device on a vertical surface, and can be used in everyday life. A vertically placed cat scratching post for use with bracket is proposed. The technical result achieved by implementing the claimed invention, in addition to the invention realizing its purpose, is the elimination of the disadvantages of analogues and thus ensuring the rapid disconnection of the bracket and the product or device placed on it, while ensuring the usual reliability of placing the product or device on a vertical surface. Another technical result is the expansion of the arsenal of technical means—brackets for products and devices.

### FIELD OF INVENTION

The proposed invention relates to household items, more specifically to brackets for a product or device located on a vertical surface, and can be used in everyday life.

BACKGROUND OF INVENTION

Various brackets and holders for various purposes are known, for example, shelf brackets (see https://www.ozon.ru/category/kronshteyn-dlya-polok/), TV brackets (https://www.ozon.ru/category/kronshteyny-dlya-televizorov-15529/), holders for planters (https://www.ozon.ru/category/tsvety-i-rasteniya-14884), and similar means of placing products and devices on a vertical surface.

A common disadvantage for the means known from the prior art is the inability to quickly disconnect a product or device placed on a bracket, for example, for changing, servicing, and replacing or recharging batteries.

Thus, there is a problem of quickly disconnecting the product or device from the bracket on which it is placed.

The claimed invention is proposed for the first time.

### SUMMARY OF THE INVENTION

The technical problem solved by the claimed invention is the implementation of brackets, and/or systems, and/or sets, and/or products, and/or devices created for the first time that do not have the disadvantages of prior art, i.e. that ensure rapid disconnection of the bracket and the products or devices placed on this bracket. Another technical problem solved by the claimed invention is the expansion of the following technical means: brackets for products and devices placed on vertical surfaces.

In addition to the implementation of the invention's purpose, the technical result achieved by the claimed invention is to eliminate the disadvantages of analogs and thus provide rapid disconnection of the bracket and the product or device placed on it, ensuring the usual reliability of placing the product or device on a vertical surface. Another technical result is the expansion of the following technical means: brackets for products and devices.

The technical result is achieved by implementing of a scratching post for animals containing a base with a recess and a scratching cloth made of a material that wears out over time under the influence of animal claws; wherein the recess contains an opposing ferromagnetic element to form a magnetic connection with a magnetic element of a bracket; wherein the bracket is an element fixed on a vertical surface forming a protrusion, allowing to place the protrusion in the recess in the base of the scratching post; wherein the protrusion contains at least one magnetic element, and the opposing ferromagnetic element is placed in the recess in such a way that, when placing the protrusion in the recess, it forms a magnetic connection; wherein the recess is made in such a way as to ensure the shifting of the magnetic element relative to the ferromagnetic element.

### BRIEF DESCRIPTION OF THE DRAWINGS

Illustrative embodiments of the claimed invention are described in detail below with reference to the attached drawings, which are included in this document by reference, containing:

FIG. 1 shows one approximate implementation of the claimed bracket 100, as an example, but not a limitation.

FIG. 2 shows one approximate version of the product 200 connected to the bracket 100, as an example, but not a limitation.

FIG. 3 shows another approximate version of the product 200 connected to the bracket 100, as an example, but not a limitation.

FIG. 4 shows approximate connection options of the bracket 100 and the product 200, as an example, but not a limitation.

FIG. 5 shows approximately how the bracket 100 is placed in the recess 202 of the product 200, as an example, but not a limitation.

FIG. 6 shows another approximate implementation of the claimed bracket 100, as an example, but not a limitation.

FIG. 7 shows one approximate version of the product 200 connected to the bracket 100 according to the second embodiment, as an example, but not a limitation.

FIG. 8 shows an approximate embodiment of the ferromagnetic element 201 (not shown in this drawing) shift relative to the magnetic element 101 in one version of the product 200 when using the bracket 100 in the second embodiment, as an example, but not a limitation.

FIG. 9 shows an approximate embodiment of the ferromagnetic element 201 (not shown in this drawing) shift relative to the magnetic element 101 in another version of the product 200 when using the bracket 100 in the second embodiment, as an example, but not a limitation.

FIG. 10, shows a rear view for two approximate embodiments of the product 200, intended for use with the bracket 100 in the first embodiment, as an example, but not a limitation.

FIG. 11 shows a rear view for two approximate embodiments of the product 200, intended for use with the bracket 100 in another embodiment, as an example, but not a limitation.

### DETAILED DESCRIPTION OF THE PREFERRED EMBODIMENTS

In the preferred embodiment of the claimed invention, a bracket is provided for a product placed on a vertical surface, which is an element fixed on a vertical surface with the formation of a protrusion, made with the possibility of placing a protrusion in a recess in the side of the product facing the vertical surface; wherein, the protrusion contains at least one magnetic element, and the recess contains an opposing ferromagnetic element in such a way that, when placing the protrusion in the recess, the magnetic connection is formed; wherein, the recess is made in such a way as to ensure the shifting of the magnetic element relative to the ferromagnetic element.

In a particular embodiment of the claimed invention, the mentioned bracket is provided, characterized in that the product is a scratching post for animals.

In a particular embodiment of the claimed invention, the mentioned bracket is provided, characterized by the fact that the product is a decorative element.

In a particular embodiment of the claimed invention, the mentioned bracket is provided, characterized in that the product is a frame for photographs, paintings or prints.

In a particular embodiment of the claimed invention, the mentioned bracket is provided, characterized by the fact that the product is a flower pot.

In a particular embodiment of the claimed invention, the mentioned bracket is provided, characterized by the fact that the product is a wall-mounted game.

In a particular embodiment of the claimed invention, the mentioned bracket is provided, characterized in that the protrusion and recess are made to provide a shift in the horizontal or vertical direction, or that a shift is provided by rotating the product around the central perpendicular vertical surface of the axis of the recess.

The following are the embodiments of the present invention, disclosing examples of its specific implementations. However, the description is not intended to limit the scope of the rights granted by this patent. Rather, it should be assumed that the claimed invention can also be implemented in other ways that it will include different elements and conditions or combinations of elements and conditions similar to the elements and conditions described in this document, in combination with other existing and future technologies.

FIG. 1 shows one approximate implementation of the claimed bracket 100, as an example, but not a limitation. Preferably, without limitation, in one embodiment, the claimed bracket 100 is a parallelepiped with one side facing a vertical surface 300, such as, for example, without limitation, a wall of a room or building, a pillar, etc., while the surface 300 contains enough space for reliable placement of the bracket 100 on the surface 300. In this case, for example, without limitation, the bracket 100 can be fixed to the surface 300 in any known or future-known suitable way that provides a sufficiently reliable connection of the bracket 100 to the surface 300, such as, for example, but not limited to, a threaded connection, such as, for example, but not limited to, an anchor, and/or threaded and/or screw connection, as well as, without limitation, gluing, welding and etc. In addition, for example, without limitation, when the surface 300 is made of a ferromagnetic or contains a ferromagnetic region, the bracket 100 on the reverse side can be equipped with an additional magnetic element (not shown in the drawing) for reliable connection to the ferromagnetic surface 300 or its ferromagnetic part. For example, without limitation, a section of soft iron (magnetic wallpaper) and the like can be fixed on the surface 300 as a ferromagnetic region. In this case, without limitation, fixing the bracket 100 to the surface 300 by means of an anchor or threaded connection, the bracket 300 can be provided with appropriate holes through which the bracket 100 is fixed to the surface by means of a screw, including a self-tapping screw. In the case of a welded joint, the bracket 100, for example, without limitation, is made of metal, or at least contains a metal base (not shown in the drawing) of sufficient thickness suitable for forming a welded joint with a metal surface 300 or a metal portion of the surface 300. In the case of gluing, for example, without limitation, the bracket 100 has an adhesive base on the reverse side (not shown in the drawing), for example, without limitation, in the form of double-sided adhesive tape, and the surface 300 is selected such that sufficient adhesion of the tape base to the surface 300 is ensured; in addition, without limitation, the bracket 100 can be made of a material or have a base (not shown in the drawing), with the adhesion to the glue used for gluing approximately corresponding to the adhesion of the same glue to the surface 300. Thus, without limitation, fixing the bracket 100 to the surface 300 can be carried out in any suitable known or future method, which are not described in more detail further. It should be assumed that the bracket 100 necessarily forms a protrusion, when fixed to the surface 300. In this case, without limitation, the protrusion can be formed either directly by the housing of the bracket 100, or by any part protruding from the housing (not shown in the drawing). In this case, preferably, without limitation, the bracket 100 and the formed protrusion contain at least one magnetic element 101, which is the main magnetic element of the bracket 100. Preferably, without limitation, the magnetic element 101 does not occupy the entire surface of the formed protrusion, but is positioned in such a way as to ensure a reliable magnetic connection with the opposing ferromagnetic element 201 in the recess 202 of the product 200, which will be described in detail below, but at the same time it is possible to shift the ferromagnetic element 201 relative to the magnetic element 101 to ensure their rapid and convenient separation; without limitation, this is mainly due to the fact that much more strength is required to break the magnetic connection than to shear the magnets, which is especially important when using a powerful magnet as a magnetic element 101, such as, for example, without limitation, a neodymium magnet, which will inevitably require shear to separate the elements successfully.

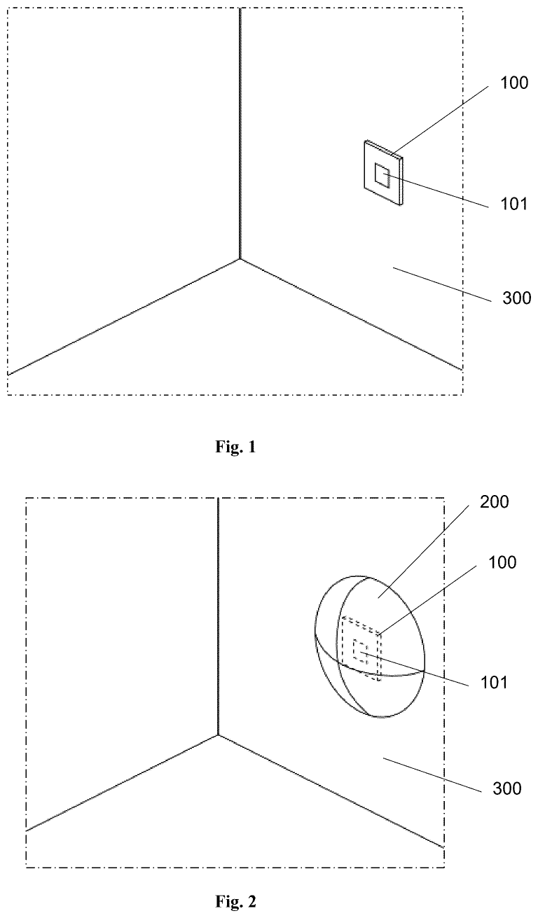

FIG. 2 shows one approximate version of the product 200 connected to the bracket 100, as an example, but not a limitation. Preferably, without limitation, a product 200 is predominantly of any suitable shape or size, the choice of which is mainly due to the strength and reliability of the magnetic connection provided, and the strength and reliability of the connection of the bracket 100 to the surface 300. Wherein, without limitation, in this embodiment, the product 200 is not predominantly flat, i.e., the thickness of the product's protruding part above the formed bracket 100 from the surface 300 is at least twice the thickness of a formed protrusion. Wherein, without limitation, the shape of such a product 200 is mainly determined by its purpose.

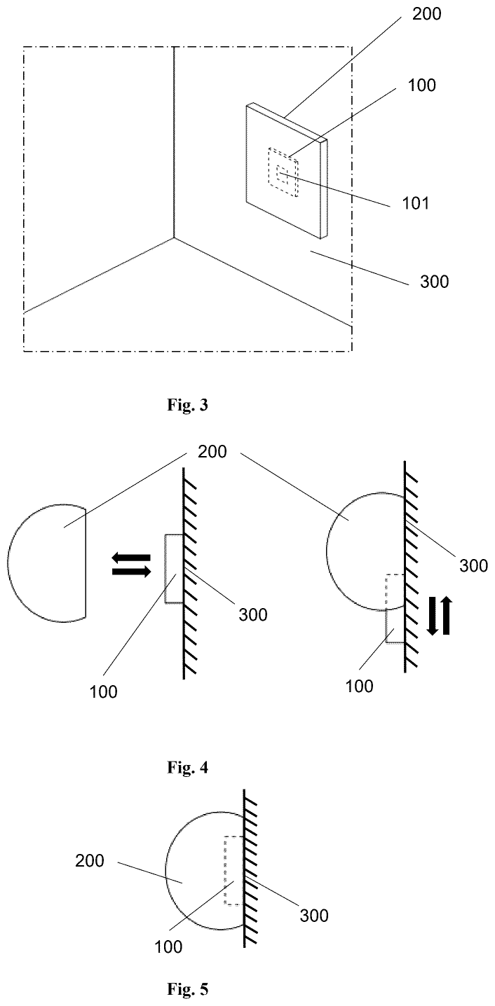

FIG. 3 shows another approximate version of the product 200 connected to the bracket 100, as an example, but not a limitation. Preferably, without limitation, in another embodiment, the product 200 is predominantly flat, i.e., the thickness of the product's protruding part formed by the bracket 100 from the surface 300 does not exceed the thickness of a formed protrusion by more than two times. Wherein, without limitation, the shape of such a product 200 is also mainly determined by its purpose.

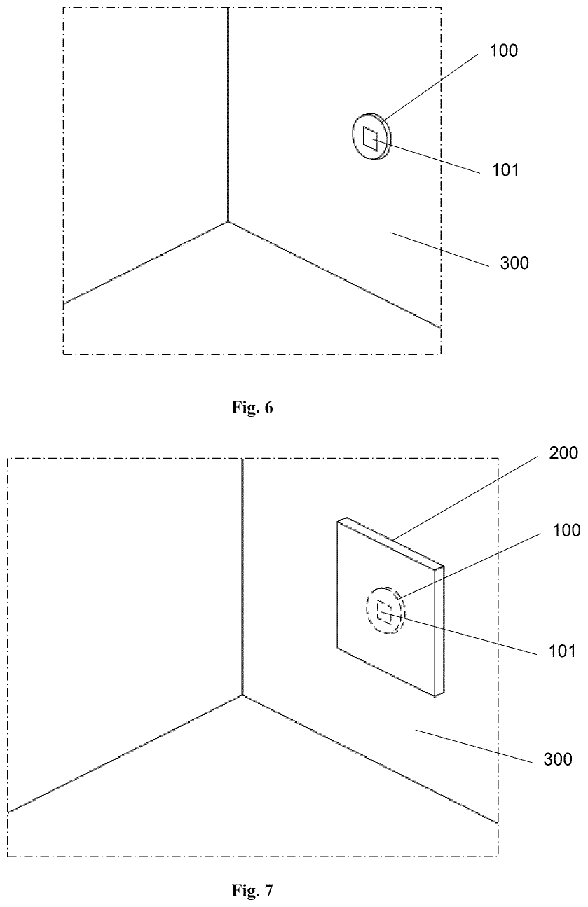

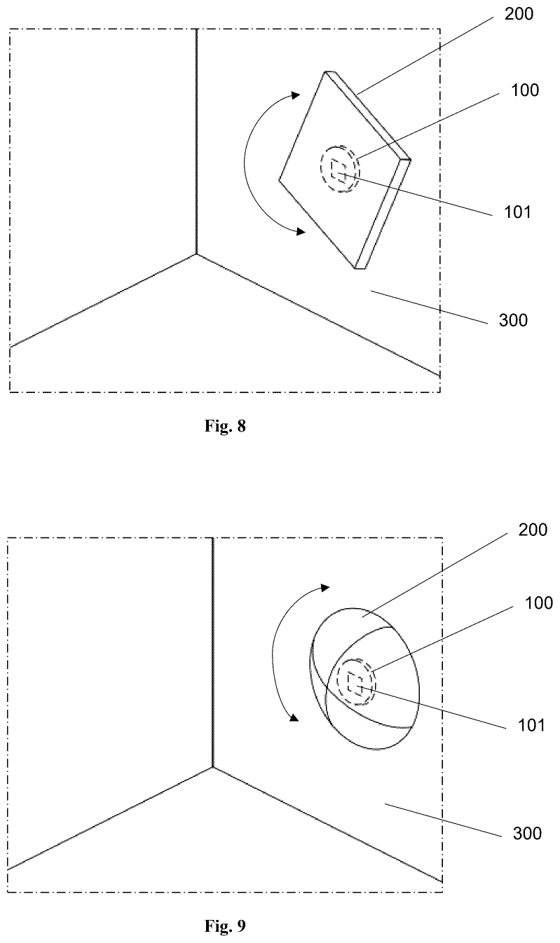

FIG. 4 shows approximate connection options of the bracket 100 and the product 200, as an example, but not a limitation. As will be shown below, the product 200 may contain a recess 202, in which the protrusion formed by the bracket 100 is located. Without limitation, it is possible to provide two connection options. According to the first option, without limitation, as shown in the left part of FIG. 4, it is ensured that the product 200 is fitted with a recess 202 in a horizontal direction towards the surface 300 on the protrusion formed by the bracket 100; in this case, the recess 202 in the product 200 is made in such a way that it has all the walls and does not allow shifting of the product 200 relative to the bracket 100 in any direction. Accordingly, without limitation, in order to disconnect the product 200 and the bracket 100, it is necessary to at least rotate the product 200 along an axis perpendicular to the surface 300, as will be shown below. According to the second option, without limitation, as shown in the right part of FIG. 4, it is ensured that the product 200 is fitted with a recess 202 in a horizontal or vertical direction parallel to the surface 300 on the protrusion formed by the bracket 100; in this case, the recess 202 in the product 200 is made in such a way that it does not have one of the walls and allows the product 200 to shift relative to the bracket 100 in the direction of the missing wall. Accordingly, without limitation, in order to disconnect the product 200 and the bracket 100, at least the product 200 should be moved in the direction opposite to the missing wall, i.e., if the wall of the recess 202 is missing from below, then the product 200 should be moved up, allowing the shift to happen. FIG. 5 shows approximately how the bracket 100 is placed in the recess 202 of the product 200, as an example, but not a limitation. Wherein, without limitation, although not shown in the drawing, it should be obvious to a specialist in this field of technology with ordinary knowledge, for whom the present invention is designed, that it is not necessary that the back wall of the product 200 contains a recess 202, and a base can be formed in the product 200, which will contain a suitable recess 202.

Wherein, it should be obvious to a specialist in this field of technology with ordinary knowledge, for whom the present invention is designed, that when the recess 202 follows the shape and size of the bracket 100, and, at the same time, the bracket 100 has angles, then shifting by rotation will be difficult or even impossible. FIG. 6 shows another approximate implementation of the claimed bracket 100, as an example, but not a limitation. Unlike the variant discussed earlier with reference to FIG. 1, the bracket 100 with reference to FIG. 6 is at least not rectangular, as shown in FIG. 1. Such a bracket 100 according to FIG. 6 is connected to the product 200 in the same way as shown with reference to FIG. 5 (left part), and differs in its functionality only in that its shape and size allows to rotate the recess 202 around the protrusion formed by the bracket 100. Without limitation, such a bracket 100 can be additionally equipped with a positioning tool, for example, a small recess in the surface of the bracket 100, into which an oncoming small protrusion falls; the protrusion is made on the surface of the recess 202 in contact with the surface of the bracket 100 (not shown in the drawing); such a positioning tool can be used to accurately position the product 200 relative to the surface 300. As an example, but not a limitation, FIG. 7 shows one approximate version of a predominantly flat product 200 connected to the bracket 100 as shown in FIG. 6. As an example, but not a limitation, FIG. 8 shows an approximate embodiment of the metal element 201 (not shown in this drawing) shifting relative to the magnetic element 101 in the version of the product 200 from FIG. 7, using the bracket 100 shown in FIG. 6. As an example, but not a limitation, FIG. 9 shows an approximate embodiment of the ferromagnetic element 201 (not shown in this drawing) shifting relative to the magnetic element 101 in another version of the product 200, when using the bracket 100 as shown in FIG. 6.

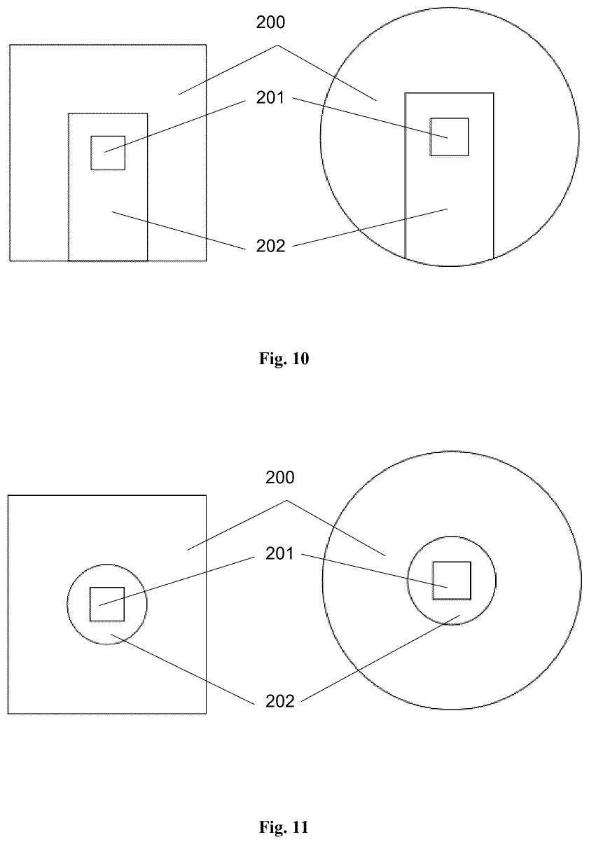

As an example, but not a limitation, FIG. 10 shows a rear view for two approximate embodiments of the product 200, intended for use with the bracket 100 as shown in FIG. 1. Wherein, without limitation, as mentioned earlier, the shape of the product 200 is not essential, since its choice may be determined by the purpose of the product, but the rear part of the product 200 or the rear part of the base of the product 200 should contain a recess 202 in which a ferromagnetic element 201 is placed, which is opposed to the magnetic element 101. Such a recess 202, although not shown, obviously does not have one of the walls and thus provides at least the possibility of shifting the ferromagnetic element 201 relative to the magnetic element 101 in a horizontal or vertical direction parallel to the surface 300; wherein, a specialist in this field of technology with ordinary knowledge, for whom the present invention is intended, should obviously see that if the size of the bracket 100 allows this, then a shift can be provided by rotating the recess 202 around the protrusion formed by the bracket 100; wherein, it should be obvious to a specialist in this field of technology with ordinary knowledge, for whom the present invention is designed, that the product 200 can be placed on two or more brackets 100, which may be due to the size of the product 200, and it should be assumed that such brackets 100 should be placed coaxially on the surface 300 in such a way that all ferromagnetic elements 201 are simultaneously shifted relative to all corresponding magnetic elements 101. As an example, but not a limitation, FIG. 11 shows a rear view for two approximate embodiments of the product 200, intended for use with the bracket 100 as shown in FIG. 6. In contrast to what has been said with reference to FIG. 10, the recesses 202 in this case have all walls and are essentially circular or shaped in such a way that the ferromagnetic element 201 is shifted relative to the magnetic element 101 solely by rotating the recess 202 around the protrusion formed by the bracket 100.

Wherein, it should be obvious to a specialist in this field of technology with ordinary knowledge, for whom the present invention is designed, that the magnetic element 101 and the ferromagnetic element 201 can be swapped, i.e., that the product 200 contains a magnetic element 101, and the bracket 100 contains a ferromagnetic element 201. Wherein, without limitation, the product 200 can have its own magnetic element, and the magnetic element 101 remains in the bracket 100, and such magnetic elements are opposite, which ensures their attraction to each other and can provide a more reliable connection than that between a magnet and a ferromagnetic.

For example, without limitation, the product 200 is a scratching post 200 for animals. Typically, without limitation, a cat scratching post has a base with a cloth placed on it, made in such a way as to gradually wear out due to exposure to the claws of an animal, for example, a Maine Coon cat. Typically, the scratching post is provided with a slowly wearing material, such as, but not limited to, jute rope, cotton rope, sisal, carpet flooring, or cardboard. A common disadvantage of existing scratching posts is their non-interchangeability, and the impossibility to simply replace the scratching material; wherein, as a rule, it is necessary to attach the scratching post to the wall exclusively with screws and dowels. Wherein, without limitation, it should be assumed that the scratching post 200 material is affected when an animal, stretching, begins to sharpen its claws down the surface on which the scratching post is fixed. Thus, it is necessary to ensure a reliable connection with the bracket 100, including when the animal tries to move the scratching post 200 down. For this purpose, without limitation, the recess 202 of the scratching post 200 has all walls, or does not have only a lower or side wall, which is due to preventing the shift of the ferromagnetic element 201 relative to the magnetic element 101. Wherein, when fixed to the bracket 100 using suitable magnets and a ferromagnet, a reliable connection is provided to tear off the material of the scratching post 200 and the bracket 101, and in case of material wear, the scratching post 200 can easily be replaced with a new one by quick and simple disconnection. Wherein, any suitable shape of the scratching post 200 can be chosen, as shown earlier; also, without limitation, when the scratching post is not predominantly flat, as shown earlier, it nevertheless contains a base with a recess 202 in which the protrusion formed by the bracket 100 can be placed.

Thus, a set may also be provided that includes at least some previously mentioned bracket 100 and at least some previously described product 200. Also, it is preferable that the set contains one previously described bracket 100 and several interchangeable previously described products 200.

The present description of the claimed invention implementation demonstrates only particular embodiments and does not limit other embodiments of the claimed invention, since possible alternative embodiments of the claimed invention that do not go beyond the scope of information specified in this application should be obvious to a specialist in this field of technology with the usual qualifications for whom the claimed invention is designed.

1. An animal scratcher comprising a base with a recess and a scratching panel made of a material that wears out over time under animal's claws; wherein the recess contains an opposite ferromagnetic element that creates a magnetic coupling with a magnetic element of a bracket; wherein the bracket is an element that is fixed to a vertical surface to form a ledge, adapted to place the ledge into a recess provided in the base of the scratcher; wherein the ledge comprises at least one magnetic element, and the recess holds an opposite ferromagnetic element, so that said opposite element contacts the magnetic element to create a magnetic coupling when the ledge is placed into the recess; wherein the recess is designed, so as to provide a shift of the magnetic element relative to the ferromagnetic element.
